(19) United States
(12) Patent Application Publication
(10) Pub. No.: US 2026/0138037 A1
(43) Pub. Date: May 21, 2026

(54) WATER ATTRACTION MANAGEMENT SYSTEM

(71) Applicant: WHITEWATER WEST INDUSTRIES LTD., Richmond (CA)

(72) Inventor: Aaron MENDELSON, Richmond (CA)

(21) Appl. No.: 19/391,630

(22) Filed: Nov. 17, 2025

Related U.S. Application Data
(60) Provisional application No. 63/722,000, filed on Nov. 18, 2024.

(51) Int. Cl. A63G 31/00; G06T 1/00; G06V 20/52

(52) U.S. Cl. CPC A63G 31/007; G06T 1/0007; G06V 20/53

(57) ABSTRACT

A system may include a waterslide having a waterslide entrance and a waterslide exit. The system may include a first camera positioned at the waterslide entrance in which the first camera may capture a first video feed. The system may include a second camera positioned at the waterslide exit in which the second camera may capture a second video feed. The system may include a processing device that may: determine an incoming guest count at the waterslide entrance by detecting a ride vehicle occupancy at the waterslide entrance based on the first video feed; determine an outgoing guest count at the waterslide exit by detecting the ride vehicle occupancy at the waterslide exit based a second video feed; and match the incoming guest count and the outgoing guest count.

### RELATED APPLICATION

This application claims the benefit of U.S. Provisional Application No. 63/722,000, filed November 18, 2024, the disclosure of which is incorporated herein by reference in its entirety.

### BACKGROUND

The examples discussed in the present disclosure are related to a water attraction management system.

Unless otherwise indicated herein, the materials described herein are not prior art to the claims in the present application and are not admitted to be prior art by inclusion in this section.

Amusement parks, including water parks, face numerous operational challenges. For example, a large number of guests pass through the parks. Furthermore, a number of different attractions may be in operation and may use a lot of personnel to run efficiently. Water parks are amusement parks with water-based attractions such as swimming pools, water slides, splash pads, and the like and may face their own challenges. Systems, methods, and devices of increasing efficiency in managing amusement parks, such as water parks, may be useful.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, a system may include a waterslide having a waterslide entrance and a waterslide exit. The system may include a first camera positioned at the waterslide entrance in which the first camera may capture a first video feed. The system may include a second camera positioned at the waterslide exit in which the second camera may capture a second video feed. The system may include a processing device that may: determine an incoming guest count at the waterslide entrance by detecting a ride vehicle occupancy at the waterslide entrance based on the first video feed; determine an outgoing guest count at the waterslide exit by detecting the ride vehicle occupancy at the waterslide exit based a second video feed; and match the incoming guest count and the outgoing guest count.

A method may include one or more of: capturing a first video feed at a waterslide entrance; capturing a second video feed at a waterslide exit; determining an incoming guest count at the waterslide entrance by detecting a ride vehicle occupancy at the waterslide entrance based on the first video feed; determining an outgoing guest count at the waterslide exit by detecting the ride vehicle occupancy at the waterslide exit based a second video feed; or matching the incoming guest count and the outgoing guest count.

A device may include a processing device. The processing device may: receive a first video feed at a waterslide entrance; receive a second video feed at a waterslide exit; determine an incoming guest count at the waterslide entrance by detecting a ride vehicle occupancy at the waterslide entrance based on the first video feed; determine an outgoing guest count at the waterslide exit by detecting the ride vehicle occupancy at the waterslide exit based a second video feed; and/or match the incoming guest count and the outgoing guest count.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example of the dispatch system with barrier arm in the occupied position.

FIG. 2 illustrates an example of the dispatch system with various positions for the barrier arm, signal lights, and sensor.

FIG. 3 illustrates an example front elevation of the dispatch system with various positions for the barrier arm, signal lights, and sensor.

FIG. 4 illustrates an example of the barrier arm, sensor and signal components of the dispatch system.

FIG. 5 illustrates an example of a waterslide exit and waterslide runout zone.

FIG. 6 illustrates an example dispatch dashboard.

FIG. 7 illustrates a process flow of computer vision for a waterslide.

FIG. 8 illustrates a diagrammatic representation of a machine in the example form of a computing device within which a set of instructions, for causing the machine to perform any one or more of the methods discussed herein, may be executed.

### DESCRIPTION

Amusement parks face numerous challenges in managing their operations. For example, amusement parks use different systems to move people through attractions. Operators may provide access to a ride when other guests have exited the ride. In the case of waterslides, operators may provide access to a next guest when the waterslide has been vacated. However, determining whether a guest has vacated the waterslide and has traveled a safe distance from the waterslide exit can be challenging because the waterslide exit may be located quite a distance from the waterslide entrance. The process may be controlled by different operators, i.e., an operator at the top of the waterslide and an operator at the bottom of the waterslide. However, this increases the number of operators per waterslide and thus increases the total employee headcount.

This disclosure provides for a system and method for managing water attractions (e.g., slides, runouts, splash areas) using advanced computer vision and guest data profiling. The system may enhance safety, optimize throughput, provide guest personalization, and enhance monetization in amusement parks and water parks. The system incorporates artificial intelligence (AI)-assisted dispatch utilizing computer vision to monitor and count the number of riders boarding the slide. This ensures real-time tracking and optimizes dispatch sequences, significantly enhancing rider safety by preventing potential overcrowding or mismanagement.

A computer vision system may be placed at the entrance and/or exit of a water slide to count the number of guests entering and exiting the slide. The computer vision system may ensure that the same number of guests who enter the waterslide also exit the waterslide to facilitate safe dispatch of the next rider and triggering state transitions in the ride dispatch system. The computer vision system may allow for waterslide throughput optimization, ride safety assurance, and/or automated dispatch control.

Examples of the present disclosure will be explained with reference to the accompanying drawings.

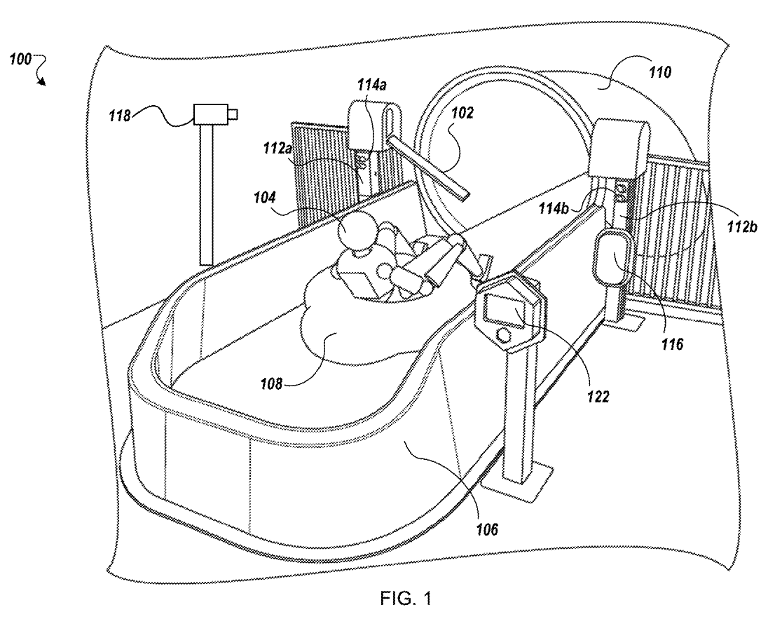

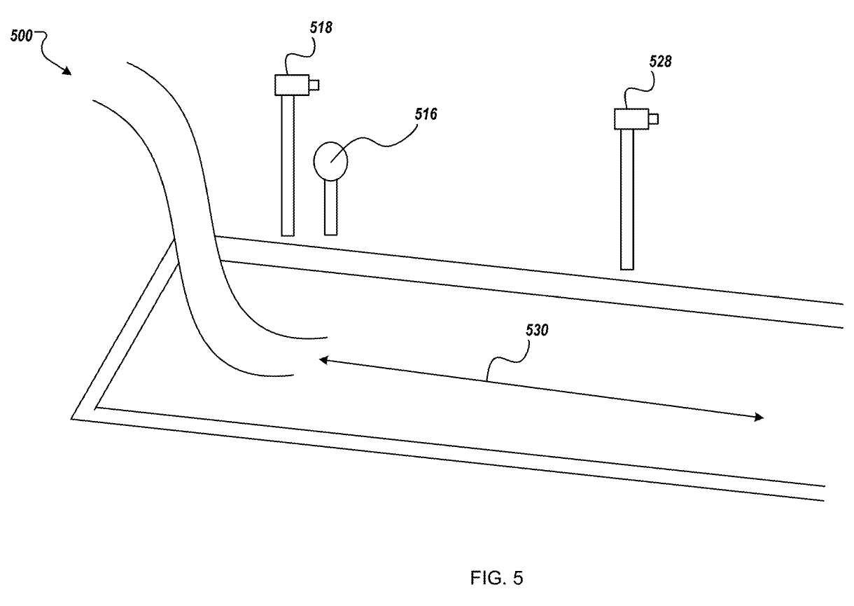

As illustrated in FIGS. 1 and 5, the computer vision system may be used with a waterslide attraction. The system may include a waterslide including a waterslide entrance 100 (as illustrated in FIG. 1) and a waterslide exit 500 (as illustrated in FIG. 5). The system may include a first camera 118 positioned at the waterslide entrance 100, in which the first camera 118 may capture a first video feed. The first camera 118 may use computer vision to detect ride vehicle occupancy. The system may include a second camera 518 (as illustrated in FIG. 5) positioned at the waterslide exit 500 in which the second camera may capture a second video feed. The second camera 518 may use computer vision to detect ride vehicle occupancy.

The system may include a processing device. The processing device may determine an incoming guest count at the waterslide entrance 100 by detecting a ride vehicle occupancy at the waterslide entrance 100 based on the first video feed. The processing device may determine an outgoing guest count at the waterslide exit 500 by detecting the ride vehicle occupancy at the waterslide exit 500 based a second video feed. The processing device may use an algorithm to match incoming and outgoing guest counts. For example, the algorithm may include one or more operations such as incrementing a counter when an incoming guest enters the waterslide and decrementing a counter when an outgoing guest exits a waterslide. When the counter is zero, then the algorithm may determine that the incoming and outgoing guest counts match.

The processing device may use ride state monitoring that may be tied to slide occupancy. The processing device may use computer vision to detect the ride vehicle occupancy at the waterslide entrance and use computer vision to detect the ride vehicle occupancy at the waterslide exit.

Computer vision may be used with any suitable hardware including a power source, an image acquisition device (e.g., camera), a processor, and/or a communication device. In one example, the computer vision system may use visible light cameras that may operate at 30 frames per second or 60 frames per second. In another example, the computer vision system may use e.g., structured light 3D scanners, thermographic cameras, hyperspectral imagers, radar imaging, LiDAR scanners, magnetic resonance images, side-scan sonar, synthetic aperture sonar, or the like.

The operations involved in computer vision may include one or more of: image acquisition, pre-processing, feature extraction, detection, high-level processing, and/or decision making. Image acquisition may be used on specific frames captured from a video camera. Pre-processing (including re-sampling, noise reduction, contrast enhancement, or the like) may be performed on the image. Various features, such as lines or more complex features, may be extracted from the image. Detection may be performed e.g., to detect a rider. High-level processing may classify an image into a specific object. Decision-making may determine whether the object matches the rider.

Computer vision may use AI and/or machine learning to classify images and/or analyze data. For example, object detection may involves neural network-based approaches and/or non-neural approaches. Some examples of non-neural approaches include one or more of Viola-Jones object detection framework, scale-invariant feature transform, or the like. Some examples of neural approaches include region proposals or the like. Some examples of machine learning include supervised learning, which may be used to train data to classify images. Machine learning may use various models such as artificial neural networks, decision trees, random forest regression, support vector machines, regression analysis, Bayesian networks, Gaussian processes, genetic algorithms, belief functions, rule-based models, or the like.

When analyzing the first video feed from the first camera 118 or analyzing the second video feed from the second camera 518, sensors may be used to determine the frame of the first video feed or the second video feed that may be analyzed. The system may include a first sensor 116 at the waterslide entrance. The first sensor 116 may determine a frame of the first video feed to analyze to determine the ride vehicle occupancy at the waterslide entrance 100. The system may include a second sensor 516 at the waterslide exit 500. The second sensor 516 may determine a frame of the second video feed to analyze to determine the ride vehicle occupancy at the waterslide exit 500.

A processing device may determine when the waterslide is occupied based on one or more of the first video feed or the second video feed without using sensors located within the waterslide. The slide occupancy state logic may be triggered using image analysis. Using image data, the system can determine whether a slide is occupied or unoccupied without physical sensors inside the waterslide. This allows for simplified hardware installations, lower maintenance costs, and flexible deployment across varied attraction types. The ride vehicle 108 may not use vehicle sensors. Therefore, video stream analysis may be used to detect an unoccupied state or an occupied state. This waterslide state logic (e.g., unoccupied state or occupied state) may be linked to dispatch control.

In addition or alternatively, the first sensor 116 at or near the entrance to the waterslide may sense the presence of a ride vehicle moving along its path, may not use a paired sensor (i.e. transmitter and receiver), and may be accessible from the attraction platform. The second sensor 516 at or near the exit 500 of the waterslide may be similar to the first sensor 116 at the waterslide entrance 100.

As the rider 104 enters into the waterslide, the first sensor 116 (which may use radar or light detection and ranging (LiDAR) technology, or which may use any other suitable sensor system) may sense the ride vehicle 108 and change the state of the waterslide to the occupied state. As a result, the traffic light may be red and the barrier arm 102 may be in a closed position. The waterslide may be in the occupied state until the ride vehicle 108 exits the waterslide and is sensed by the second sensor 516 or an operator presses a button that releases the occupied state back to the unoccupied state.

The waterslide entrance 100 may include a validation device 122 for access control validation, including a sensor or series of sensors that may read credentials of a person (employee or guest) and look up whether they have an entitlement to access that waterslide.

A processing device may grant guest access to the waterslide using facial authentication. Generally, facial recognition access may be used for entitlement management in park environments. Guests may be enrolled in a facial recognition system linked to a member account. Access to rides (e.g., waterslides), amenities, or entitlements (e.g., VIP areas, reserved seating, and/or FastPass) may be granted based on facial authentication rather than physical passes or wristbands. This may provide a hands-free park access experience with personalized guest interaction, entitlement verification, and fraud prevention. The facial authentication feature may be used with water park environments, which may involve challenging conditions like wet skin, dynamic lighting, and high guest volumes.

Guests may have a member account that may be associated with one or more entitlements. For example, after exiting a waterslide, a guest may use funds stored in their member account at a concession stand using facial authentication. After the concession stand, the guest may enter a VIP area based on facial recognition at an access control point. Thus, the member account with associated entitlements may be integrated with a guest’s identify and controlled using facial recognition.

Light signaling devices may indicate one or more of an occupied status or an unoccupied status for the waterslide. For example, when the signal lights 114a, 114b are red, then the waterslide may be occupied. When the signal lights 114a, 114b are green, then the waterslide may be unoccupied.

Waterslide dispatch systems may sense a ride vehicle by using a photo-eye a few feet down the waterslide which may change the state of the waterslide from the unoccupied state to the occupied state. This may be visualized by a traffic light at the top of the waterslide which lets the operator know the current state of the slide (e.g., occupied or unoccupied). Once a ride vehicle gets to the bottom of the waterslide, the vehicle may trigger another photo-eye or another operator at the base of the slide who presses a button which may change the state of the waterslide from occupied to unoccupied.

However, this presents a challenge because photo-eyes may be unreliable for a number of reasons. Water may splash on the lenses and cause the unit to unreliably sense ride vehicles. When maintenance on the photo-eye is to be performed, high reaches are often used to get to the units that are several feet down the slide and mounted to the outside of the flume. In addition, there may be ambiguity with respect to the signaling lights.

Dispatch logic for the waterslide may be integrated with the light signaling system. The processing device may trigger a state transition in a ride dispatch system to allow entry at the waterslide entrance 100 when the waterslide has an unoccupied status. The processing device may trigger a state transition in a ride dispatch system to forbid entry at the waterslide entrance 100 when the waterslide has an occupied status.

An example of dispatch control, which may be used with vision-based detection of guest throughput, is illustrated in FIG. 1. The dispatch system may include a barrier arm 102. The rider 104 may enter the entrance tub 106 seated in a ride vehicle 108 with the barrier arm 102 in the lowered position. In this lowered position, the rider 104 may be physically barred from entering the flume 110. On pedestals 112a, 112b may be signal lights 114a, 114b (e.g., red and green stoplight configuration) that may be used as a visual signal to the rider 104 that the rider 104 may not enter the flume 110. The pedestal 112b may include a first sensor 116 (e.g., entrance sensor) which may sense the presence of the rider 104 in the entrance tub 106. The dispatch system may include a microcontroller (e.g., including multiple inputs and outputs that may be connected to a network).

Artificial intelligence may also assist in dispatch. The water attraction management system may use advanced AI algorithms to optimize the dispatch process dynamically. This system may integrate data from multiple sources, including computer vision, queue sensors, and historical operational metrics. The AI may evaluate these data points to predict potential bottlenecks, adjust dispatch timings, and enhance guest safety.

For example, the AI system may detect anomalies, such as overcrowding at the slide entry, and automatically delay dispatch to prevent safety hazards. The AI may adapt to real-time operational changes, such as increased rider flow during peak hours, by reducing the delay time between dispatches to maximize throughput while maintaining safety standards. The system may use predictive modeling to anticipate ride usage patterns based on historical data and external factors such as weather and park attendance trends. In addition or alternatively, a processing device may optimize a slide throughput based on the incoming guest count and the outgoing guest count.

The barrier arm 102 may act as a physical and visual safety mechanism so that guests may not enter a slide when the waterslide is occupied. The barrier arm 102 may be constructed from lightweight, durable materials that prevent injury while clearly signaling the status of the waterslide. Integrated sensors may communicate with the dispatch control system, allowing the barrier arm 102 to lift automatically when the water slide is ready. In scenarios where the waterslide becomes unavailable due to a safety issue or operational delay, the barrier arm 102 may lower to block entry and trigger a visual indicator (e.g., red light) and an audio alert. The barrier arm 102 may accommodate varying attraction layouts, with adjustable heights and lengths. The barrier arm 102 may be powered by an energy-efficient motor and include a manual override for emergency situations. In addition or alternatively, the barrier arm system may open and close based on the state of the dispatch system, may have soft barriers to keep riders safe, and may have breakaway barriers in case a rider enters the waterslide without authorization.

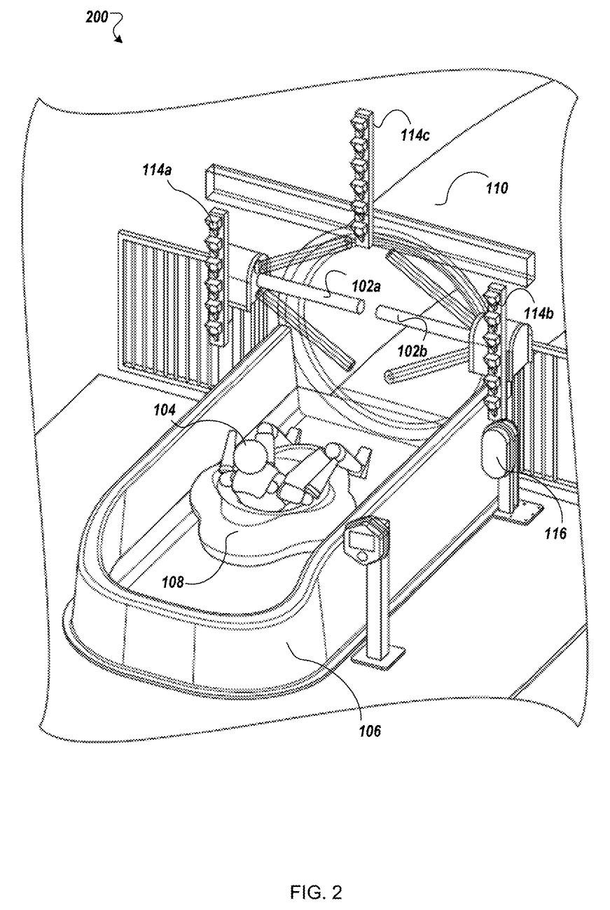

FIGS. 2 to 4 illustrate various examples of dispatch systems at a waterslide entrance. FIG. 2 illustrates the dispatch system 200 at the waterslide entrance with various positions for the barrier arms 102a, 102b, signal lights 114a, 114b, 114c and first sensor 116. There may be at least three different positions for the barrier arms 102a, 102b. In the lower position for the barrier arms 102a, 102b (similar to that depicted in FIG. 1, but depicted in outline form in FIG. 2), the rider may be physically barred from entering the flume 110. In the middle orientation (depicted in solid lines and solid fill in FIG. 2), the barrier arms 102a, 102b may be raised to a position parallel to the entrance platform surface, indicating that the rider 104 is free to enter the flume 110. Alternatively or in addition, the barrier arms 102a, 102b might be raised to an upper position (depicted in outline form in FIG. 2) to indicate that the rider 104 is free to enter the flume 110.

FIG. 2 also depicts a dispatch system 200 that shows the signal lights 114a, 114b, 114c that resemble a racing-style light tree. The lights might include a preparation status (e.g., but lighting an orange light at the top), and then sequentially lighting one or more yellow lights and finally a green light stacked on the light tree. The first sensor 116 (e.g., entrance sensor) which may sense the presence of the rider 104 in the entrance tub 106.

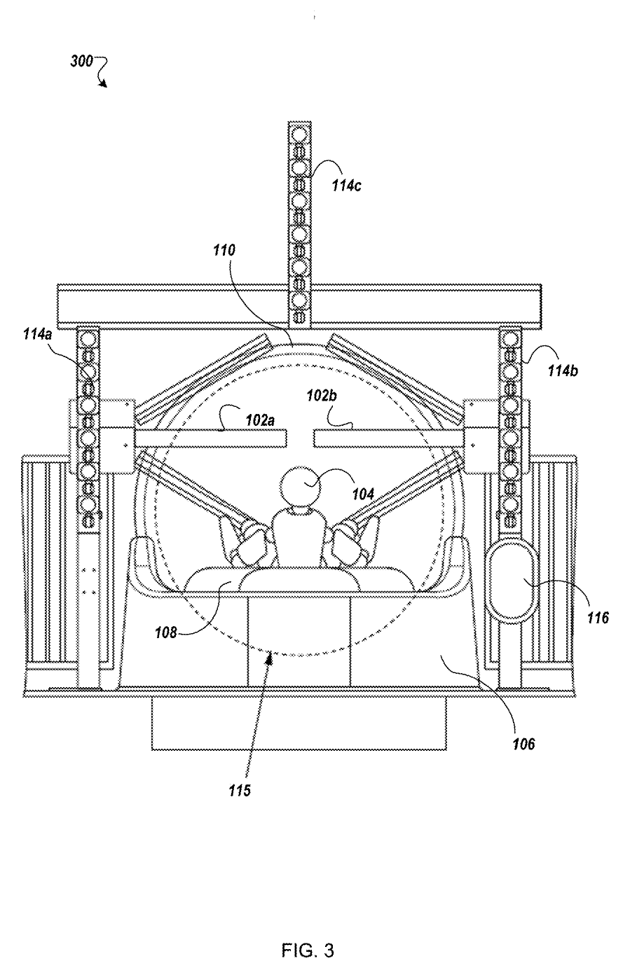

FIG. 3 illustrates a front elevation view of the dispatch system 300 with various positions for the barrier arms 102a, 102b, signal lights 114a, 114b, 114c, and first sensor 116. A central area 115 of the waterslide entrance 300 may include a ride vehicle 108 and a rider 104. The first sensor 116 may sense the rider 104 in the ride vehicle 108 when the rider 104 is in the central area 115 of the waterslide entrance 300. The rider may be barred from entering the flume 110 when the barrier arms 102a, 102b are in a lowered position.

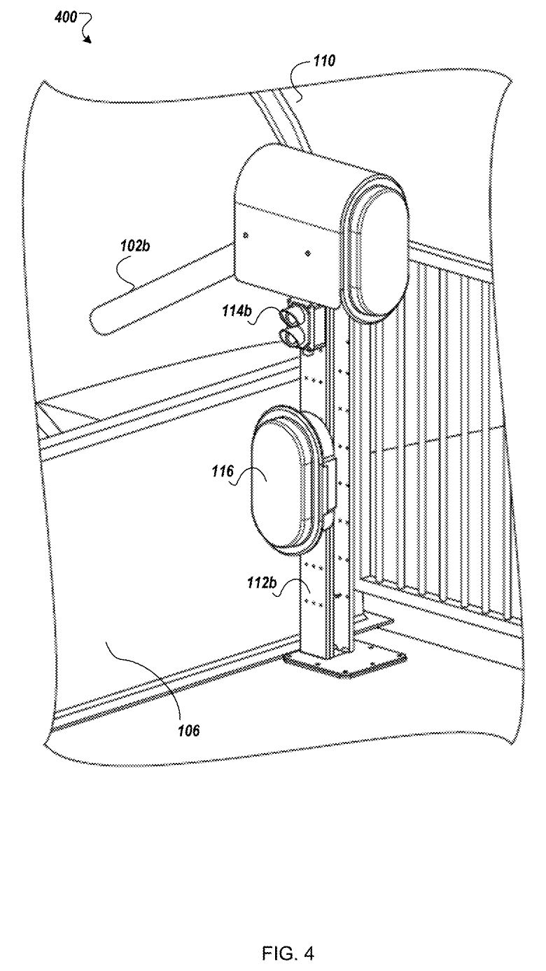

FIG. 4 illustrates a perspective view of the barrier arm 102b, first sensor 116, and signal lights 114b of the dispatch system 400. As indicated, the first sensor 116 may be positioned in the lower position on the pedestal 112b as in FIGS. 1-3. Alternatively, the first sensor 116 may be placed higher on the pedestal 112b to protect the first sensor 116 and to more fully integrate the first sensor 116 with the barrier arm housing.

As illustrated in FIGS. 1 to 4, integrating the barrier arms 102a, 102b with the first sensor 116 and the overall dispatch system may reduce guests from entering the flume 110 when the guests are not permitted to enter the flume 110. As a result, the number of attendants at the waterslide entrance may be reduced.

The base of the waterslide, as illustrated in FIG. 5, may have a second sensor 516 that may detect when a guest has cleared the runout zone (e.g., a shallow pool area at the end of a slide). The system may allow the next guest to dispatch when the previous guest has exited to a safe distance, reducing collision risk. Thus, runout zone and/or splash area monitoring may be used with real-time dispatch gate control to provide an intelligent ride clearance system.

Computer vision clearance systems may be used in the runouts or splash zones. A processing device may use computer vision to detect that a guest has exited a runout zone 530. A camera-based vision system may include a third camera 528 positioned at a runout zone 530. The third camera 528 may capture a third video feed. Alternatively or in addition, the second camera 518 may be used at the runout zone 530 to capture a video feed. The third video feed may be used to determine that a guest has exited the runout zone 530. Real-time object detection and movement tracking may be used to determine that the guest has exited the runout zone 530.

When the guest has exited the runout zone 530, the processing device may trigger a state transition in a ride dispatch system to allow entry at the waterslide entrance. Alternatively, when the guest has not exited the runout zone 530, the processing device may trigger a state transition in a ride dispatch system to forbid entry at the waterslide entrance.

The processing device may include minimum clearance threshold distance logic to determine a minimum clearance threshold for the runout zone 530. For example, the minimum clearance threshold distance logic may determine that a 25 feet distance from the waterslide exit may allow another rider to enter the waterslide.

The processing device may determine a rider travel distance after exiting the waterslide using computer vision to generate a statistical distribution based on the rider travel distance. That is, the distance that a rider travels after exiting a slide (in the runout zone or splashdown zone) may be used to generate a statistical distribution (e.g., a normal distribution) of distances. The system may allow parks to analyze performance, guest type trends, or even dynamically adjust ride timing based on average distances. In some examples, the statistical distribution can be based on various inputs (e.g., estimated height or weight of the rider) to determine distances traveled in the runout zone 530. Aggregating statistics based on distance traveled after exiting a waterslide may be used to facilitate guest flow optimization, rider experience analysis, and performance benchmarking across attractions.

Computer vision may be used in other ways to enhance a guest experience. For example, custom photo generation may use AI face mapping in themed scenes (e.g., in which faces of guests are superimposed in different scenes). Guests’ faces may be captured and dynamically mapped onto themed or humorous character templates using AI-powered face detection and replacement. These novelty photos may be offered to guests as purchasable keepsakes, increasing park revenue and guest engagement. For example, AI face mapping may be used to determine one or more of the number and/or gender of various riders and may superimpose the faces of the group into different scenes based on the number and/or gender of the various riders. There may be a template library with themed bodies or scenes that may be used. These novelty photos may be used for personalized souvenir generation and may be integrated with photo booths and/or various mobile apps. The photos may be generated and previewed in real-time or near-real-time.

Computer vision may be used for guest journey tracking. For example, computer vision may be integrated with wearable technology. Radio frequency identification (RFID) wristbands and/or mobile apps may track guest movement throughout the park. This data, in conjunction with computer vision data, may be used to analyze guest behavior, optimize park layout, and personalize the guest experience. For instance, the system may recommend nearby attractions or food options based on queue times and individual preferences. In addition or alternatively, enhanced safety alerts may be provided. For example, notifications may be sent to parents when children wearing wristbands leave designated areas or when computer vision detects that children have left a designated area or have wandered too far from parents, thereby enhancing safety measures for families.

Computer vision may be integrated with various guest-facing features. The system may connect with guest-facing mobile apps to provide e.g., real-time ride wait times, notifications about ride readiness or maintenance closures, and/or personalized ride recommendations based on guest preferences. Gamified elements may be provided. For example, gamified elements may enhance guest engagement, such as awarding points for visiting multiple attractions or using energy-efficient features like walking instead of trams.

Computer vision may be integrated with various third-party systems to enhance the guest experience. For example, computer vision and associated systems may be used with smart park systems for parking, ticketing, and/or food services to create a seamless experience for guests and enhance operational efficiencies. Internet of Things (IoT) may be integrated with the system e.g., from third-party manufacturers, such as advanced queue management systems or high-tech water sensors.

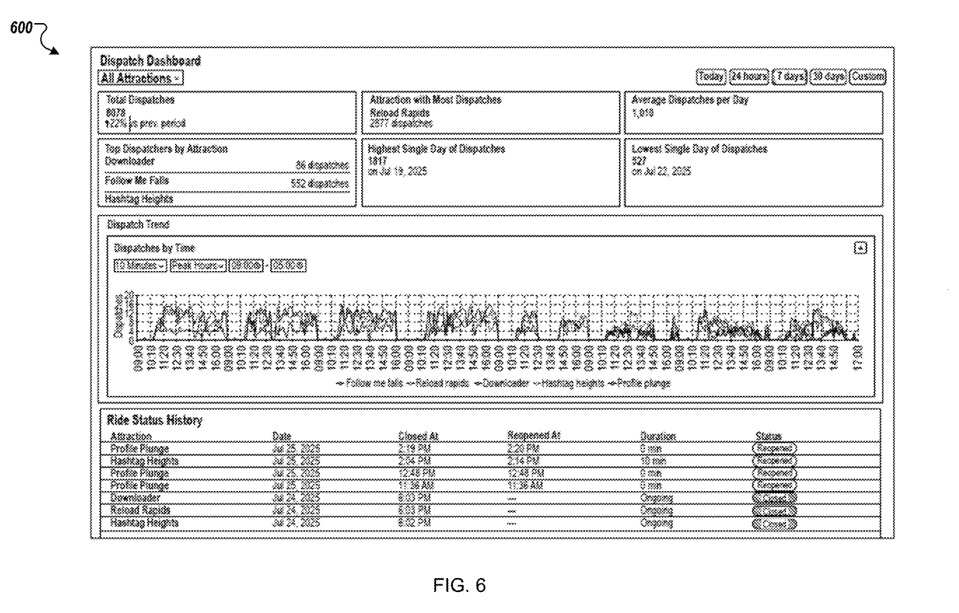

As illustrated in FIG. 6, precision data logging may be used to capture, store, and analyze operational data. Various performance metrics such as dispatch rates, throughput, and queue lengths may be captured, stored, and analyzed. The collected data may be processed in real-time and visualized through a dashboard 600 that may provide park operators with actionable insights. The dashboard may include various data such as the total number of dispatches, the attraction with the most dispatches, the average dispatches per day, the top dispatchers by attraction, the highest single day of dispatches, the lowest single day of dispatches, the dispatch trend by time, and the ride status history.

Operators may use this information to identify inefficiencies, such as slow dispatch rates or excessive wait times, and implement corrective measures. For instance, the system could recommend reallocating employees to high-demand attractions or adjusting queue configurations to streamline guest flow. Additionally, historical data may be stored in a secure database, allowing operators to conduct trend analyses, and improve long-term operational strategies. The dashboard 600 may integrate custom filters and visualization tools to display metrics specific to particular attractions or time periods. Operators may export reports for stakeholder presentations or to analyze the impact of operational changes over time.

The interactive dashboard may have various features and may serve as a central hub for operational data and insights. Designed for ease of use, the dashboard may present information through customizable widgets and visualizations, such as heatmaps, bar graphs, and trend lines. Some features may include: (1) employee training metrics, (2) weather impact analysis, (3) throughput and efficiency tracking, or the like.

The dashboard may display individual employee performance metrics, such as average dispatch times and safety compliance rates. Operators may use these insights to identify top performers and areas for improvement, tailoring training programs accordingly.

By overlaying operational metrics with historical weather data, the dashboard may highlight correlations between weather conditions and ride usage. For example, operators may see how temperature fluctuations impact guest preferences for specific attractions.

The system may visualize throughput rates for attractions, allowing operators to pinpoint inefficiencies. Real-time updates may help the staff respond dynamically to changes in guest flow.

The dashboard may support multi-user access with role-based permissions, ensuring that employees view data relevant to their responsibilities. Additionally, operators may simulate different scenarios using historical data to plan for peak seasons or special events.

The dashboard may be driven by AI to provide predictive analytics. For example, real-time crowdsourcing data may be used to: (1) predict park attendance based on historical trends, ticket, and weather forecasts, (2) enable dynamic adjustments to staff allocation, ride availability, and energy consumption based on real-time attendance predictions, and (3) recognize failures patterns by using machine learning to identify failure patterns across multiple attractions to recommend preemptive upgrades or redesigns.

Advanced data visualization tools may be used. Heat maps and predictive flow models may show guest density across the park in real time. Predictive flow modeling may recommend routing adjustments for managing crowd distribution. Operators may define and track their own key performance indicators, such as energy savings, guest satisfaction scores, or ride downtime.

Different types of data may be collected and analyzed including dispatch rates per attraction; throughput rates per attraction; water quality (measured in gallons per minute (GPM), chlorine levels, etc.); energy consumption per attraction; and wait times, and the like.

Dispatch rates may be updated and calculated at the time the barrier arm closes and the state of the dispatch system moves to the occupied state. The dispatch rate may be the measure of time between a ride vehicle's entrance into a waterslide.

Throughput may be measured by counting individual guests who enter an attraction. The water attraction management system may use a computer vision algorithm to count guests as they enter into the attraction. Throughput may be the count of an occupant over a specific period of time.

The water attraction management system may include sensors to pull data from the water systems at a park to create an overall view into the quality at any given time as well as over time. These sensors may measure a variety of attributes that make up a plumbing system for an attraction, including but not limited to the following: chlorine levels; pH level; and water flow (gpm).

Energy consumption may be measured as savings per appropriate attraction. Pumps may be spun down and time and flow rates may be measured and recorded to the water attraction management system. Sensor data may include e.g., flow rate; chlorine levels; and pH balance.

The water attraction management system may fuse the data collected from sensors specific to water attractions and link that together with the data collected from dispatches, throughput, operating hours and weather to create a predictive maintenance model that lets operators know about replacement long before the failure mode would be seen. By analyzing variables such as water flow rates, pump efficiency, and chemical balance, the system identifies patterns indicative of wear and tear. For example, the system might detect a gradual decline in pump performance and recommend scheduling a replacement before a critical failure occurs. Predictive maintenance not only minimizes downtime but also reduces long-term costs by extending the lifespan of equipment.

Energy management may be facilitated using various data that is collected. Guest-detection sensors may be integrated with pump control systems to optimize energy consumption. When no guests are detected in a queue, the system may signal to the pumps to reduce water flow, conserving energy, and reducing equipment wear. As guests approach the queue, the system may gradually restore water flow to ensure the attraction is fully operational by the time the first rider enters. This dynamic adjustment may enhance sustainability without compromising guest experience.

Guest-detecting sensors may be placed in the queuing area. As guests move through the queue area, the count may be collected and the guests may be logged as being in queue. Separately, the system may track the throughput of the attractions as noted above. As a guest exits the queue and enters the attraction, the system may remove them from the in queue status. Logic may be applied to these logs to calculate wait times per attraction or per groups of attractions.

In addition to data about the guests and rides at the park, data on employees may be collected. For example, employee data may be used to provide employees with immediate feedback on their performance metrics, such as dispatch efficiency or safety compliance. In addition or alternatively, shifts may be optimized by using AI to recommend optimal shift schedules based on attendance patterns, employee performance, and/or fatigue data.

In one aspect of the water attraction management system, attendants may use a dedicated device (e.g., validation device 122) to scan an ID (e.g., an employee ID) that represents the attendant within the system. ID scanning may link the employee to a particular attraction. Scanning may include a timestamp and allow for an understanding of which employee is linked to an attraction at a particular time. When the employee rotates to a new position, the employee may tap his or her ID again at the new position, thereby updating the system and the data which may be useful for safety compliance, efficiency, and training purposes.

Data may be combined with other date to provide additional insights. Weather data, for instance, may be added to water quality as well as total dispatches to help an operator understand how the park is used and how to plan for maintenance.

Real-time weather data may be combined with historical weather data. The system may receive live weather feeds, including temperature, wind speed, humidity, and precipitation, from integrated sensors or third-party services. These data points may be analyzed alongside operational metrics to optimize ride availability and guest experience.

For instance, if the system detects incoming rain, it can proactively adjust ride schedules and alert operators to potential safety risks. Historical weather data allows the system to identify trends, such as reduced guest flow during colder months, enabling operators to plan staffing and maintenance schedules accordingly. In addition, real-time updates on attraction status through mobile apps or digital signage may be provided to guests.

Weather data may be used for dynamic pricing or predictive maintenance. Dynamic ticket pricing based on weather forecasts may encourage attendance during off-peak or challenging weather conditions. In addition, maintenance protocols may be triggered by specific weather patterns, such as extreme heat or high humidity.

Data may for environmental sustainability may be collected and used. For example, water recycling metrics may be collected. Water quality and consumption monitoring may incorporate data on water recycling efficiency. Metrics for measuring the impact of conservation efforts, such as reduced water usage per guest over time may be collected. The carbon footprint may be determined based on one or more of energy usage and guest transportation data.

A safety checklist may be generated. Aspects of water slide readiness, such as mechanical integrity, water quality, and safety barrier functionality may be determined. The checklist may include mandatory and optional items, ensuring thorough compliance with safety standards. Real-time updates may allow supervisors to monitor the inspection process remotely. If an issue is identified, the system may automatically log the problem and notify relevant personnel, such as the maintenance team, to expedite resolution. The system may track the status of these issues until they are resolved, providing a complete audit trail for compliance purposes. For example, if a slide's water flow is below the safety threshold, the system may trigger an alert and recommend shutting down the attraction until the issue is rectified. Operators may access historical inspection records to identify recurring issues and prioritize maintenance schedules accordingly.

Data can be integrated for emergency management and incident reporting. For example, automated alerts may be sent to staff during safety incidents (e.g., water contamination or mechanical failure). In addition, real-time tracking of guest locations may assist in evacuation procedures. An incident reporting dashboard may provide functionality for staff to log and track incidents, enabling systematic follow-ups and compliance with safety regulations.

The system disclosed herein may be scaled to waterslides or other attractions that may be added in the future which may minimize integration time and costs. The AI may be trained using new data to ensure the AI may evolve alongside park operations and industry advancements.

The system may track and ensure compliance with local and international safety and operational regulations. For example, the system may be optimized to provide accessibility for guests with disabilities, such as priority queueing and ride adjustments.

The collected data may be used to provide guest demographics and behaviors to inform marketing campaigns and promotional efforts.

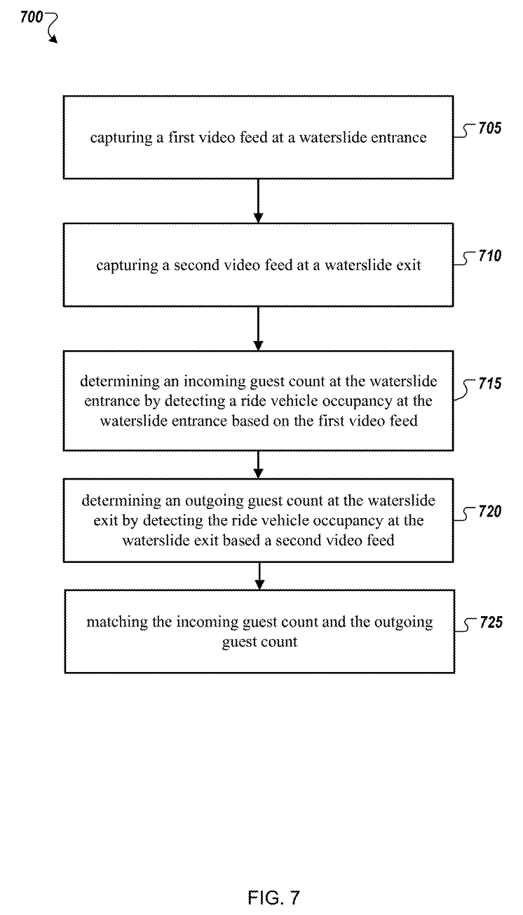

FIG. 7 illustrates a process flow of an example method 700, in accordance with at least one example described in the present disclosure. The method 700 may be arranged in accordance with at least one example described in the present disclosure.

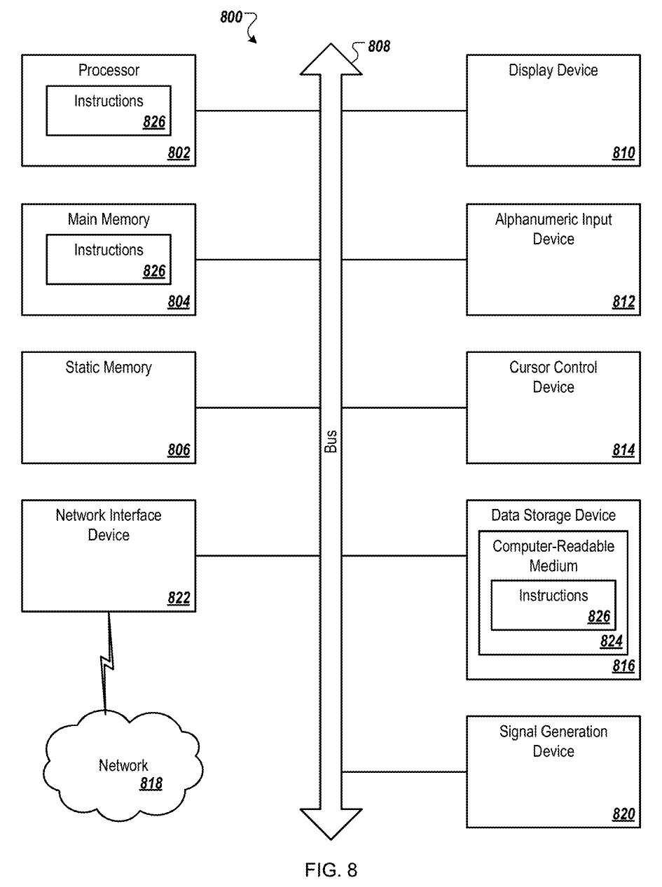

The method 700 may be performed by processing logic that may include hardware (circuitry, dedicated logic, etc.), software (such as is run on a computer system or a dedicated machine), or a combination of both, which processing logic may be included in the processing device 802 of FIG. 8, or another device, combination of devices, or systems.

The method 700 may begin at block 705 where the processing logic may capture a first video feed at a waterslide entrance. The processing logic may capture a second video feed at a waterslide exit, as shown by block 710. The processing logic may determine an incoming guest count at the waterslide entrance by detecting a ride vehicle occupancy at the waterslide entrance based on the first video feed, as shown by block 715. The processing logic may determine an outgoing guest count at the waterslide exit by detecting the ride vehicle occupancy at the waterslide exit based a second video feed, as shown by block 720. The processing logic may match the incoming guest count and the outgoing guest count, as shown by block 725.

The method may include one or more additional operations. The method may include using computer vision to detect the ride vehicle occupancy at the waterslide entrance and using computer vision to detect the ride vehicle occupancy at the waterslide exit. The method may include triggering a state transition in a ride dispatch system to allow entry at the waterslide entrance when the waterslide has an unoccupied status. The method may include triggering a state transition in a ride dispatch system to forbid entry at the waterslide entrance when the waterslide has an occupied status. The method may include optimizing a slide throughput based on the incoming guest count and the outgoing guest count.

The method may include using computer vision to detect the guest has exited the runout zone. The method may include triggering a state transition in a ride dispatch system to allow entry at the waterslide entrance when the guest has exited the runout zone. The method may include triggering a state transition in a ride dispatch system to forbid entry at the waterslide entrance when the guest has not exited the runout zone. The method may include determining a minimum clearance threshold for the runout zone. The method may include determining a rider travel distance after exiting the waterslide. The method may include generating a statistical distribution based on the rider travel distance.

The method may include determining when the waterslide is occupied based on one or more of the first video feed or the second video feed without using sensors located within the waterslide. The method may include granting guest access to the waterslide using facial authentication. The method may include capturing one or more faces from one or more guests, and/or mapping the one or more faces from the one or more guests onto a photograph.

Modifications, additions, or omissions may be made to the method 700 without departing from the scope of the present disclosure. For example, in some examples, the method 700 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 8 illustrates a diagrammatic representation of a machine in the example form of a computing device 800 within which a set of instructions, for causing the machine to perform any one or more of the methods discussed herein, may be executed. The computing device 800 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 800 includes a processing device (e.g., a processor 802), a main memory 804 (e.g., read-only memory (ROM), flash memory, dynamic random access memory (DRAM) such as synchronous DRAM (SDRAM)), a static memory 806 (e.g., flash memory, static random access memory (SRAM)) and a data storage device 816, which communicate with each other via a bus 808.

Processing device 802 represents one or more general-purpose processing devices such as a microprocessor, central processing unit, or the like. More particularly, the processing device 802 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also include one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein.

The computing device 800 may further include a network interface device 822 which may communicate with a network 818. The computing device 800 also may include a display device 810 (e.g., a liquid crystal display (LCD) or a cathode ray tube (CRT)), an alphanumeric input device 812 (e.g., a keyboard), a cursor control device 814 (e.g., a mouse) and a signal generation device 820 (e.g., a speaker). In at least one example, the display device 810, the alphanumeric input device 812, and the cursor control device 814 may be combined into a single component or device (e.g., an LCD touch screen).

The data storage device 816 may include a computer-readable storage medium 824 on which is stored one or more sets of instructions 826 embodying any one or more of the methods or functions described herein. The instructions 826 may also reside, completely or at least partially, within the main memory 804 and/or within the processing device 802 during execution thereof by the computing device 800, the main memory 804 and the processing device 802 also constituting computer-readable media. The instructions may further be transmitted or received over a network 818 via the network interface device 822.

While the computer-readable storage medium 824 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A system, comprising:
a waterslide comprising a waterslide entrance and a waterslide exit;
a first camera positioned at the waterslide entrance, wherein the first camera is operable to capture a first video feed;
a second camera positioned at the waterslide exit, wherein the second camera is operable to capture a second video feed; and
a processing device operable to:
determine an incoming guest count at the waterslide entrance by detecting a ride vehicle occupancy at the waterslide entrance based on the first video feed;
determine an outgoing guest count at the waterslide exit by detecting the ride vehicle occupancy at the waterslide exit based a second video feed; and
match the incoming guest count and the outgoing guest count.

2. The system of claim 1, wherein the processing device is further operable to:
use computer vision to detect the ride vehicle occupancy at the waterslide entrance; and
use computer vision to detect the ride vehicle occupancy at the waterslide exit.

3. The system of claim 1, further comprising:
a first sensor at the waterslide entrance, wherein the first sensor is operable to determine a frame of the first video feed to analyze to determine the ride vehicle occupancy at the waterslide entrance; and
a second sensor at the waterslide exit, wherein the second sensor is operable to determine a frame of the second video feed to analyze to determine the ride vehicle occupancy at the waterslide exit.

4. The system of claim 1, further comprising:
a light signaling device operable to indicate one or more of an occupied status or an unoccupied status for the waterslide.

5. The system of claim 1, wherein the processing device is further operable to:
trigger a state transition in a ride dispatch system to allow entry at the waterslide entrance when the waterslide has an unoccupied status.

6. The system of claim 1, wherein the processing device is further operable to:
trigger a state transition in a ride dispatch system to forbid entry at the waterslide entrance when the waterslide has an occupied status.

7. The system of claim 1, wherein the processing device is further operable to:
optimize a slide throughput based on the incoming guest count and the outgoing guest count.

8. The system of claim 1, further comprising:
a third camera positioned at a runout zone, wherein the third camera is operable to capture a third video feed, and
wherein the processing device is further operable to determine a guest has exited the runout zone.

9. The system of claim 8, wherein the processing device is further operable to:
use computer vision to detect the guest has exited the runout zone.

10. The system of claim 9, wherein the processing device is further operable to:
trigger a state transition in a ride dispatch system to allow entry at the waterslide entrance when the guest has exited the runout zone.

11. The system of claim 9, wherein the processing device is further operable to:
trigger a state transition in a ride dispatch system to forbid entry at the waterslide entrance when the guest has not exited the runout zone.

12. The system of claim 8, wherein the processing device is further operable to:
determine a minimum clearance threshold for the runout zone.

13. The system of claim 8, wherein the processing device is further operable to:
determine a rider travel distance after exiting the waterslide.

14. The system of claim 13, wherein the processing device is further operable to:
generate a statistical distribution based on the rider travel distance.

15. The system of claim 1, wherein the processing device is further operable to:
determine when the waterslide is occupied based on one or more of the first video feed or the second video feed without using sensors located within the waterslide.

16. The system of claim 1, wherein the processing device is further operable to:
grant guest access to the waterslide using facial authentication.

17. The system of claim 1, wherein the processing device is further operable to:
capture one or more faces from one or more guests; and
map the one or more faces from the one or more guests onto a photograph.

18. A method, comprising:
capturing a first video feed at a waterslide entrance;
capturing a second video feed at a waterslide exit;
determining an incoming guest count at the waterslide entrance by detecting a ride vehicle occupancy at the waterslide entrance based on the first video feed;
determining an outgoing guest count at the waterslide exit by detecting the ride vehicle occupancy at the waterslide exit based a second video feed; and
matching the incoming guest count and the outgoing guest count.

19. The method of claim 18,
using computer vision to detect the ride vehicle occupancy at the waterslide entrance; and
using computer vision to detect the ride vehicle occupancy at the waterslide exit.

20. A device, comprising:
a processing device operable to:
receive a first video feed at a waterslide entrance;
receive a second video feed at a waterslide exit;
determine an incoming guest count at the waterslide entrance by detecting a ride vehicle occupancy at the waterslide entrance based on the first video feed;
determine an outgoing guest count at the waterslide exit by detecting the ride vehicle occupancy at the waterslide exit based a second video feed; and
match the incoming guest count and the outgoing guest count.
